(19) United States
(12) Patent Application Publication
(10) Pub. No.: US 2017/0198784 A1
(43) Pub. Date: Jul. 13, 2017

(54) METHOD AND APPARATUS FOR TRANSMITTING TORQUE IN AN ACTUATOR

(71) Applicant: Hanon Systems, Daejeon (KR)

(72) Inventor: Houssam Soubjaki, Huntington Woods, MI (US)

(21) Appl. No.: 15/388,011

(22) Filed: Dec. 22, 2016

Related U.S. Application Data
(60) Provisional application No. 62/277,758, filed on Jan. 12, 2016.

(51) Int. Cl. F16H 1/20; F16H 19/08

(52) U.S. Cl. CPC F16H 1/20; F16H 19/08

(57) ABSTRACT

A rotary actuator assembly includes a common shaft, a drive, and a gear assembly. The common shaft has a body portion and a neck portion, and defines a first axis of the actuator assembly. The drive includes a pinion, having an aperture formed therethrough, wherein the neck portion of the common shaft is slidably received in the aperture. The gear assembly includes an intermediate gear and a drive gear. The drive gear is rotationally fixed to the body portion of the common shaft. The intermediate gear rotates about a second axis parallel to the first axis, and is configured to transfer rotational movement from the pinion to the drive gear, wherein a major gear of the intermediate gear engages the pinion and a minor gear of the intermediate gear engages the drive gear, wherein.

### CROSS-REFERENCES TO RELATED APPLICATIONS

This application claims priority to U.S. Provisional Patent No. 62/277,758, filed on Jan. 12, 2016, the disclosure of which is incorporated herein by reference in its entirety.

### FIELD OF THE INVENTION

The invention relates generally to a rotary actuator assembly, and particularly, to a rotary actuator assembly of a motor vehicle.

### BACKGROUND

There is a continuing effort in the automotive industry to reduce size and weight of individual vehicle components in order to improve overall vehicle efficiency.

Rotary actuators are commonly used in motor vehicle components to effect rotational motion of an output shaft, such as in a throttle body or HVAC system, for example.

Conventional rotary actuators are generally controlled using a brushed direct current (DC) motor. In order to sufficiently control the rotation of the output shaft, the actuator assembly typically requires a series of gear reductions between the DC motor and the output shaft. For example, typical rotary actuators include a first gear reduction between the motor and an intermediate gear, and a second gear reduction between the intermediate gear and a drive gear of the output shaft.

Although effective, the prior art includes several complications. For example, brushed DC motors are relatively large, and particularly long. Thus, to incorporate the intermediate gear while minimizing the overall size of the housing, the DC motor must be radially offset from the output shaft, wherein a body of the DC motor is adjacent and parallel to the output shaft. By offsetting the DC motor to incorporate the intermediate gear, the housing of the vehicle component may be specially designed to include a space for the DC motor. For example, when the rotary actuator is used in an electronic throttle body, a housing of the electronic throttle body must be specially designed to also incorporate the DC motor. Additionally, the offset configuration requires the DC motor to be installed into the housing separate from the output shaft, thereby increasing complexity and assembly time of the electronic throttle body. Similarly, when a rotary actuator assembly having a DC motor is used in other vehicle components, special design considerations must be taken into account for the vehicle component, in order to minimize overall size and weight.

Accordingly, there exists a need in the art for an improved rotary actuator assembly, wherein the size and complexity of the rotary actuator are minimized.

### SUMMARY OF THE INVENTION

In concordance with the instant disclosure, an improved rotary actuator assembly, wherein the size and complexity of the rotary actuator are minimized is surprisingly discovered.

In one embodiment a rotary actuator assembly includes a common shaft, a drive, and a gear assembly. The common shaft has a body portion and a neck portion, and defines a first axis of the actuator assembly. The drive includes a pinion having an aperture formed therethrough, wherein the neck portion of the common shaft is slidably received in the aperture. The gear assembly includes an intermediate gear and a drive gear. The drive gear is rotationally fixed to the body portion of the common shaft. The intermediate gear rotates about a second axis parallel to the first axis, and is configured to transfer rotational movement from the pinion to the drive gear, wherein a major gear of the intermediate gear engages the pinion and a minor gear of the intermediate gear engages the drive gear, wherein.

In another embodiment, a rotary actuator assembly includes a common shaft having a body portion and a neck portion. A pinion is rotatable about the neck portion of the common shaft. The assembly further includes a drive gear axially spaced from the pinion, and rotatably fixed to the body portion of the common shaft. An intermediate gear is rotatable about a second axis, which is parallel to the first axis. The intermediate is a stepped gear, and is configured to engage each of the pinion and the drive gear. The pinion is coupled to a brushless DC motor, wherein a rotational output of the motor is transferred to the drive gear via each of the pinion and the intermediate gear.

In yet another embodiment, the rotary actuator assembly includes a pinion, and a drive gear coaxially aligned with and axially spaced from the pinion. The drive gear is parallel to the pinion. A major gear is disposed axially intermediate the pinion and the drive gear, and an outer circumference of the major gear engages the pinion, wherein a rotation of the pinion affects a rotation of the major gear. A minor gear is coaxially aligned with and rotatably coupled to the major gear. An outer circumference of the minor gear engages the drive gear, wherein a rotation of the minor gear affects a rotation of the drive gear.

### BRIEF DESCRIPTION OF THE DRAWINGS

FIG. 1 is a top perspective view of a rotary actuator assembly according to the instant disclosure;

FIG. 2 is a cross-sectional view of the rotary actuator assembly of FIG. 1, taken along section line 2-2 of FIG. 1; and

FIG. 3 is an exploded top perspective view of the rotary actuator assembly of FIG. 1, wherein the rotary actuator assembly is incorporated into an electronic throttle body; and

FIG. 4 is an exploded top perspective view of an alternate embodiment of the rotary actuator assembly of FIGS. 1-3, wherein drive gear is a sector gear.

### DETAILED DESCRIPTION OF THE INVENTION

The following detailed description and appended drawings describe and illustrate various embodiments of the invention. The description and drawings serve to enable one skilled in the art to make and use the invention, and are not intended to limit the scope of the invention in any manner. In respect of any methods disclosed, the steps presented are exemplary in nature, and thus, the order of the steps is not necessary or critical.

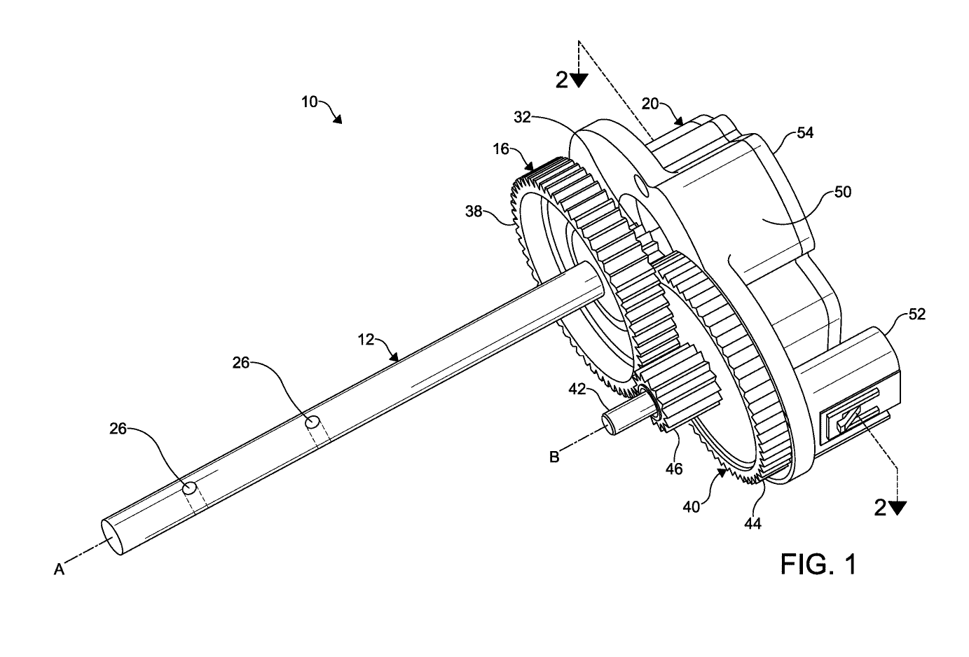

FIGS. 1-3 illustrate a rotary actuator assembly 10 in accordance with a first embodiment of the instant disclosure. The rotary actuator assembly 10 includes a common shaft 12, a drive assembly 14, a gear assembly 16, and a printed circuit board (PCB) 18, which are all at least partially enclosed within a housing 20.

The common shaft 12 of the rotary actuator assembly 10 includes a body portion 22 and a neck portion 24, and defines a first rotational axis A of the rotary actuator assembly 10. As shown, each of the body portion 22 and the neck portion 24 are cylindrical in shape, and the neck portion 24 extends axially from a distal end of the body portion 22. However, in alternate embodiments, either one or both of the body portion 22 and the neck portion 24 may have an irregular or polygonal cross section. The common shaft 12 may be formed of one or more of a metal, a polymer, or a composite material.

In the illustrated embodiment, a diameter or cross-sectional area of the neck portion 24 is less than a diameter or cross-sectional area of the body portion 22, wherein the common shaft 12 is stepped. In yet another embodiment, the diameter or cross-sectional area of the neck portion 24 may be greater than that of the body portion 22. In yet another embodiment, the common shaft 12 may be continuously formed, wherein the diameters or cross-sectional areas of the neck portion 24 and the body portion 22 are the same.

The body portion 22 may further include a fastening means 26 for configured to engage an output 28 of the rotary actuator assembly 10. For example, the fastening means 26 may be configured for fixedly coupling the output 28 to the common shaft 12.

The drive assembly 14 of the instant disclosure includes a motor 30 and a pinion 32. The pinion 32 of the drive assembly 14 is rotatably coupled to a rotor 34 of the motor 30, wherein a rotational output of the motor 30 is directly communicated to the pinion 32. As shown, a shaft portion of the pinion is received within the rotor 34. However, other means of coupling the pinion 32 to the motor 30 will be appreciated by those of ordinary skill in the art.

The drive assembly 14 includes an aperture 36 formed therethrough, wherein the aperture 36 is configured to receive a portion of the common shaft 12 therein. As shown in FIGS. 1-3, the aperture 36 is centrally formed at least partially through each of the pinion 32, wherein the motor 30 and the pinion 32 are each configured to slidingly receive the neck portion 24 of the common shaft 12 therein. A diameter of the aperture 36 is configured to provide a slip fit condition between the neck portion 24 of the common shaft 12 and the drive assembly 14, which is configured to allow rotational motion of the rotor 34 and pinion 32 relative to the neck portion 24, while minimizing radial movement of the neck portion 24 within the rotor 34. The slip fit between the drive assembly 14 and the neck portion 24 of the common shaft 12 advantageously allows the common shaft 12 and the drive gear 38 to rotate independently of the motor 30 and the pinion 32, while maintaining axial alignment of the motor 30 and the pinion 32 with the common shaft 12. For example, the slip fit may be understood to be one of a running fit and a sliding fit, as defined by ANSI B4.1. The exact slip fit condition will be selected based on an intended operating speed and load of the rotary actuator assembly 10.

In the illustrated embodiment, the motor 30 is a brushless DC motor 30. By using a brushless DC motor 30 according to the instant disclosure, the overall size, weight, and complexity of the rotary actuator assembly 10 is advantageously reduced compared to electronic throttle bodies of the prior art. Brushless DC motors provide a reduced profile compared to the brushed motors, thereby allowing the motor 30 to be mounted coaxially with the common shaft 12 without substantially increasing a length of rotary actuator assembly 10. Although a brushless DC motor 30 is included in the illustrated embodiment, it will be appreciated by those skilled in the art that other types of electrical motors having a minimal profile may be used, such as alternating current (AC) motors, induction motors, or brushed DC motors.

A rotational output of the drive assembly 14 is translated to the common shaft 12 via the gear assembly 16. In a first embodiment of the disclosure, the gear assembly 16 includes a drive gear 38 and an intermediate gear 40.

The drive gear 38 is rotationally fixed to the body portion 22 of the common shaft 12. Accordingly, the drive gear 38 and the pinion 32 are coaxially aligned along the first axis A of the rotary actuator assembly 10, wherein a space is formed intermediate the drive gear 38 and the pinion 32. The drive gear 38 may be rotationally fixed to the common shaft 12 by a mechanical means, such as a fastener, a keyway, or a frictional fit, for example. The drive gear 38 may also be adhesively fixed to the common shaft 12. The drive gear 38 is disposed axially intermediate the pinion 32 of the drive 32 and the housing 20.

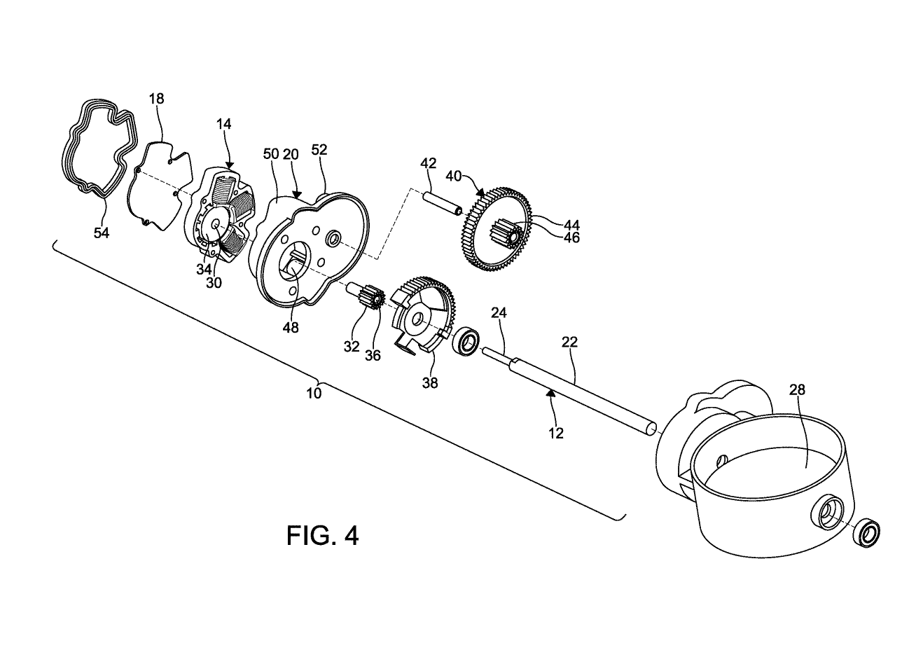

In the illustrated embodiment, the drive gear 38 is continuously formed, wherein the drive gear 38 is configured to rotate the common shaft 12 continuously, more than 360 degrees. However, in alternate embodiments, the drive gear 38 may be configured to only provide a partial rotation of the common shaft 12 about the first axis A. For example, the drive gear 38 may be a sector gear having teeth formed partially around an outer circumference thereof, as shown in FIG. 4.

The intermediate gear 40 is rotatable about a second axis B of the rotary actuator assembly 10. The second axis B is parallel to the first axis A, wherein each of the pinion 32, the intermediate gear 40, and the drive gear 38 are parallel to each other. In the illustrated embodiment, the intermediate gear 40 is coupled to an axle 42, which extends from the housing 20 and defines the second axis B.

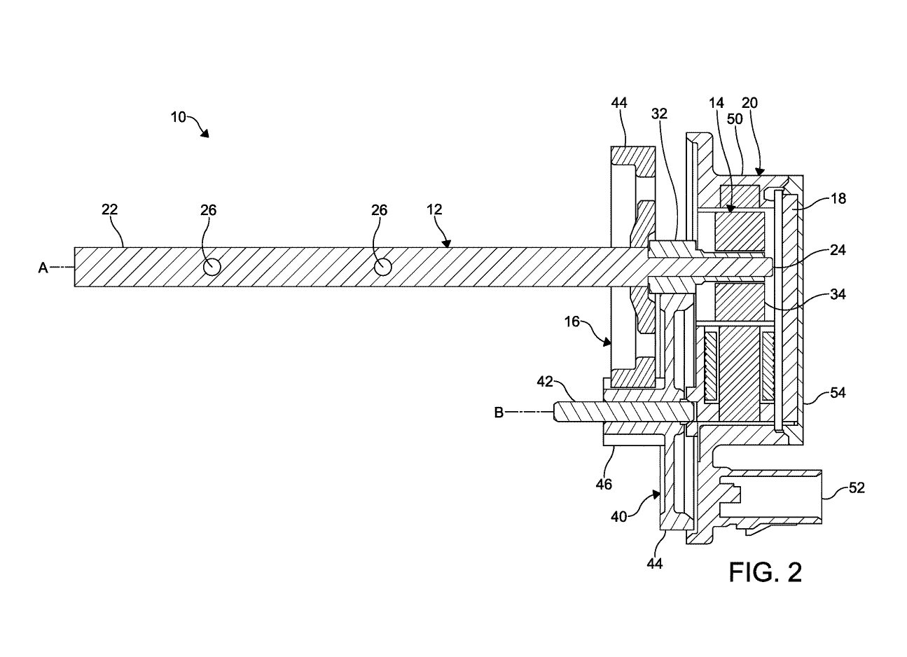

As shown in FIGS. 1 and 2, the intermediate gear 40 is configured to translate rotational motion from the pinion 32 of the drive assembly 14 to the drive gear 38. As shown, the intermediate gear 40 is a stepped gear, and includes a major gear 44 and a minor gear 46 coaxially aligned, and rotationally fixed with respect to each other. The intermediate gear 40 may be unitarily formed, wherein the minor gear 46 and the major gear 44 are formed of a single body, or may be a composite gear, wherein the minor gear 46 is separately formed from and mechanically coupled to the major gear 44.

With the second axis B offset from the first axis A, as described above, the major gear 44 is configured to engage the pinion 32. Thus, a rotational output of the motor 30 is transferred to the major gear 44 by the pinion 32, causing a counter-rotational motion of the major gear 44 and the minor gear 46 with respect to the pinion 32. As shown, the major gear 44 is axially aligned with the pinion 32, wherein a plurality of teeth on the outer circumference of the major gear 44 engage a plurality of teeth formed on an outer circumference of the minor gear 46. The minor gear 46 of the intermediate gear 40 is configured to engage the drive gear 38 in a similar manner, wherein the counter-rotational motion of the minor gear 46 is translated to the drive gear 38. Accordingly, drive gear 38 is caused to rotate in the same direction as the pinion 32.

In the illustrated embodiment of the rotary actuator assembly 10, each of the pinion 32, the major gear 44, the minor gear 46, and the drive gear 38 is configured as a cogwheel or sprocket, wherein a plurality of teeth on each one of the gears engages a plurality of teeth on a corresponding one of the other gears to effect rotational and counter-rotational motion thereof. Diameters of each of the pinion 32, the major gear 44, the minor gear 46, and the drive gear 38 are selected depending on a desired output torque and/or speed of the rotary actuator assembly 10. It will be appreciated that rotational motion may be transmitted from the drive assembly 14 to the drive gear 38 by other means, such as using frictional clutches, belts, chains, and fluid couplings, for example. The gear assembly 16 may also be configured as a worm drive, wherein a worm gear is disposed intermediate the intermediate gear 40 and the drive gear 38 to effect rotational movement of the drive gear 38.

The PCB 18 is in electrical communication with the motor 30 and at least one sensor on the drive gear 38, and functions to send inputs to the motor 30 and the sensors and receive outputs from the motor 30 and the sensors to control operation of the electronic throttle body 10.

The housing 20 of the rotary actuator assembly 10 includes a cavity 48 configured to receive at least a portion of the drive 32 and the PCB 18 therein. The cavity may be at least partially defined by a lip 50 circumscribing a perimeter of the housing 20. The housing 20 may further include a lead frame 52 formed on the flange and configured to provide electrical communication between the PCB 18 and an external controller (not shown). A cover 54 encloses the cavity 48. The configuration of the housing 20 to receive the motor 30 and the PCB 18 advantageously minimizes the overall size of the electronic throttle body 10.

In the illustrated embodiment, forward and reverse rotation are provided by the drive assembly 14, wherein the motor 30 may be operated in forward and reverse direction. However, in alternate embodiments, reverse rotation may be provided or assisted by a spring assembly (not shown). For example, the spring assembly may include a spring coupled to the common shaft 12, wherein a spring force is applied counter to the rotational output of the common shaft 12, biasing the common shaft 12 towards an initial position. The spring may be a torsion spring, a tension spring, or a compression spring. The spring assembly may further include a linkage, such as an arm extending radially from the common shaft 12 or drive gear 38, configured to cooperate with the spring to bias the common shaft 12 towards the initial position.

As discussed hereinabove, the instant disclosure beneficially incorporates a brushless DC motor 30 by configuring the common shaft 12 to be slidingly received in the drive assembly 14. This configuration also minimizes the overall size and weight of the rotary actuator assembly 10 compared to the prior art, while simultaneously improving performance.

In operation, input signals corresponding to a desired position of the output 28 are provided to the PCB from an exterior controller. In response, the PCB 18 communicates a command to the motor 30 relating to a desired rotational position of the output 28, and the motor 30 rotates to predetermined rotational position. The rotational movement of the motor 30 is transmitted to the major gear 44 of the intermediate gear 40 by the pinion 32, causing the intermediate gear 40 to rotate. In turn, the minor gear 46 of the intermediate gear 40 transmits the rotational movement to the drive gear 38. The drive gear 38, being rotationally fixed to the body portion 22 of the common shaft 12, causes the common shaft 12 to rotate. Rotation of the common shaft 12 consequently rotates the output 28 to the desired position, while the neck portion 24 of the common shaft 12 rotates freely within the motor 30 and pinion 32.

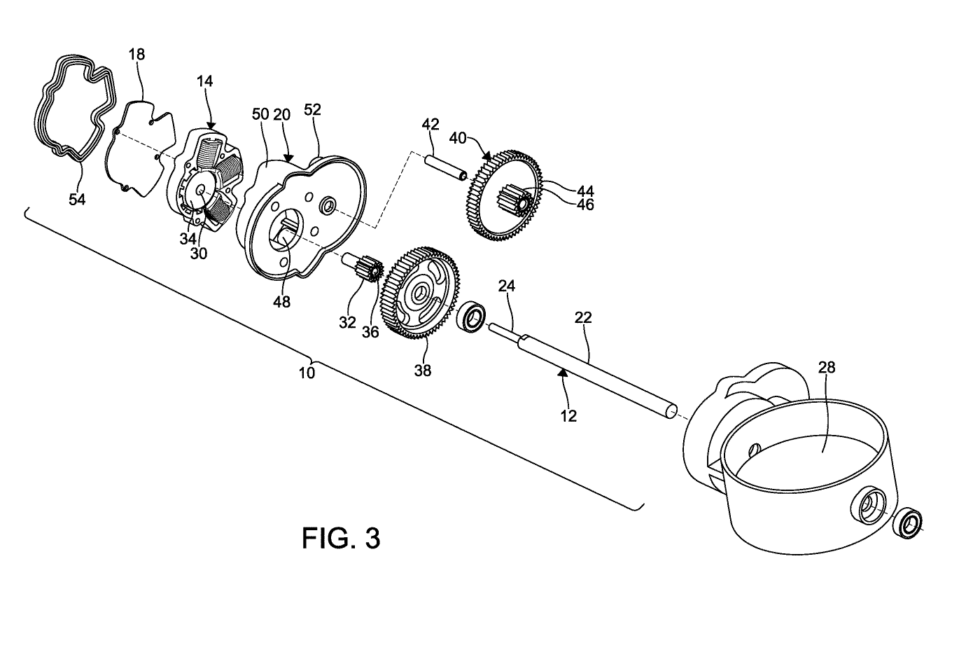

As shown in FIG. 3 and discussed above, the rotary actuator assembly 10 of the instant disclosure may be incorporated into an electronic throttle body. However, it will be appreciated that the disclosed rotary actuator assembly 10 could be beneficially incorporated into any application in a motor 30 vehicle requiring rotational motion. For example, the rotary actuator assembly 10 disclosed herein may be incorporated in one or more of: an exhaust gas recirculation valve; an exhaust gas back pressure valve; louvers, doors, and shutters in an heating, ventilation, and air-conditioning system; waste gate actuators; water, coolant, and oil valves; refrigeration valves, electronic brake actuators; tachometers; and general purpose actuators.

By configuring the rotary actuator assembly 10 according to the instant disclosure, the overall size, weight and complexity of the rotary actuator assembly 10 are advantageously reduced compared to electronic throttle bodies of the prior art, while simultaneously improving efficiency. For example, a rotatory actuator assembly according to the current disclosure has been discovered to provide a 20% reduction in weight and a 30% increase in response time compared to rotary actuators of the prior art.

Furthermore, by minimizing the overall size of the rotary actuator assembly 10, vehicle components can be modularly designed, wherein a common rotary actuator assembly 10 design can be utilized in a variety of the aforementioned applications without the need to modify the design of the rotary actuator assembly 10. Design of the vehicle components can similarly be simplified, as it is no longer necessary to accommodate the motor 30 of the rotary actuator assembly 10 in the vehicle component itself. Accordingly, product design and procurement can be streamlined.

From the foregoing description, one ordinarily skilled in the art can easily ascertain the essential characteristics of this invention and, without departing from the spirit and scope thereof, can make various changes and modifications to the invention to adapt it to various usages and conditions.

What is claimed is:

1. An rotary actuator assembly comprising;
a common shaft having a body portion and a neck portion, wherein the common shaft defines a first axis;
a drive including a pinion, wherein the pinion includes an aperture formed therethrough, the neck portion of the common shaft slidably received in the aperture; and
a gear assembly including an intermediate gear and a drive gear, the drive gear rotationally fixed to the body portion of the common shaft, the intermediate gear configured to transfer rotational movement from the pinion to the drive gear.

2. The actuator assembly of claim 1, wherein the intermediate gear is disposed on a second axis parallel to the first axis.

3. The actuator assembly of claim 1, wherein the intermediate gear includes a major gear configured to engage the pinion and a minor gear configured to engage the drive gear.

4. The actuator assembly of claim 1, wherein the minor gear is coaxial with the major gear, and wherein a diameter of the major gear is larger than a diameter of the minor gear.

5. The actuator assembly of claim 1, wherein the drive gear is a sector gear and the actuator assembly is configured to rotate the common shaft less than 360 degrees.

6. The actuator assembly of claim 1, wherein the drive gear is a continuous gear, and the actuator assembly is configured to rotate the common shaft continuously.

7. The actuator assembly of claim 1, wherein the motor is a brushless DC motor.

8. The actuator assembly of claim 1, wherein the aperture is formed through each of the pinion and the motor.

9. The actuator assembly of claim 1, wherein a cross-sectional area of the body portion is greater than a cross-sectional area of the neck portion.

10. A rotary actuator assembly comprising:
a common shaft;
a pinion rotatable about the common shaft;
a drive gear axially spaced from the pinion and rotatably fixed to the common shaft; and
an intermediate gear rotatable about a second axis, the second axis parallel to the first axis, the intermediate configured to engage each of the pinion and the drive gear.

11. The actuator assembly of claim 10, wherein the common shaft includes a body portion, and a neck portion extending from a first end of the body portion.

12. The actuator assembly of claim 11, wherein the body portion has a first diameter and the neck portion has a second diameter, the first diameter greater than the second diameter.

13. The actuator assembly of claim 12, wherein the neck portion is rotatably received by the pinion.

14. The actuator assembly of claim 10, wherein the intermediate gear is a stepped gear having a major gear engaged with the pinion, and a minor gear engaged with the drive gear.

15. The actuator assembly of claim 10, wherein the pinion is coupled to a motor.

16. The actuator assembly of claim 15, wherein the motor is brushless DC motor.

17. The actuator assembly of claim 10, further comprising an output coupled to the common shaft.

18. An rotary actuator assembly comprising:
a pinion;
a drive gear coaxially aligned the pinion;
a major gear disposed axially intermediate the pinion and the drive gear, an outer circumference of the major gear engaging an outer circumference of the pinion, wherein a rotation of the pinion affects a rotation of the major gear;
a minor gear coaxially aligned with and rotatably coupled to the major gear, the minor gear rotatably coupled to the drive gear, wherein a rotation of the minor gear affects a rotation of the drive gear.

19. The rotary actuator assembly of claim 18, further comprising a common shaft, wherein the drive gear is rotatably fixed to the common shaft.

20. The rotary actuator assembly of claim 19, wherein a portion of the common shaft is slidably received in the pinion.
